(19) United States
(12) Patent Application Publication
(10) Pub. No.: US 2026/0327508 A1
(43) Pub. Date: Oct. 22, 2026

(54) MANAGEMENT OF TARS AND OILS IN GASIFICATION PROCESSES

(71) Applicant: SunGas Renewables, Inc., Houston, TX (US)

(72) Inventors: Andrew KRAMER, St. Charles, IL (US); David LAMONT, Houston, TX (US)

(21) Appl. No.: 19/110,515

(22) PCT Filed: Sep. 12, 2023
(86) PCT No.: PCT/US2023/073980

§ 371 Date: Mar. 11, 2025

Related U.S. Application Data
(60) Provisional application No. 63/405,995, filed on Sep. 13, 2022.

(51) Int. Cl. C10J 3/84; B01D 53/04; B01J 20/06; B01J 20/28; B01J 20/34; C01B 3/56; C10K 1/02; C10K 1/22; C10K 1/26; C10K 3/00; C10K 3/02

(52) U.S. Cl. CPC C10J 3/84; B01D 53/04; B01J 20/06; B01J 20/28059; B01J 20/3433; B01J 20/3458; C01B 3/56; C10K 1/024; C10K 1/026; C10K 1/22; C10K 1/26; C10K 3/005; C10K 3/006; C10K 3/008; C10K 3/023; B01D 2253/1124; B01D 2253/306; B01D 2257/702; B01D 2259/40084; B01D 2259/402; C01B 2203/042; C01B 2203/048; C10J 2300/1618

(57) ABSTRACT

Gasification processes are disclosed, according to which tars and oils present in the gasifier effluent (gasifier effluent tar) are effectively removed by adsorption onto a solid adsorbent, or optionally converted by contact with a solid catalyst. In either case, particular aspects relate to the advantageous control of adsorbed tar and catalyst coke, particularly in terms of (i) how solid adsorbents or solid catalysts may be “positioned” within the overall process and/or (ii) the conditions to which these materials may be subjected, in order to derive important benefits. These include improved process integration, with the ability to recover hydrogen and carbon values of the adsorbed tar and catalyst coke and/or reduce CO₂ output.

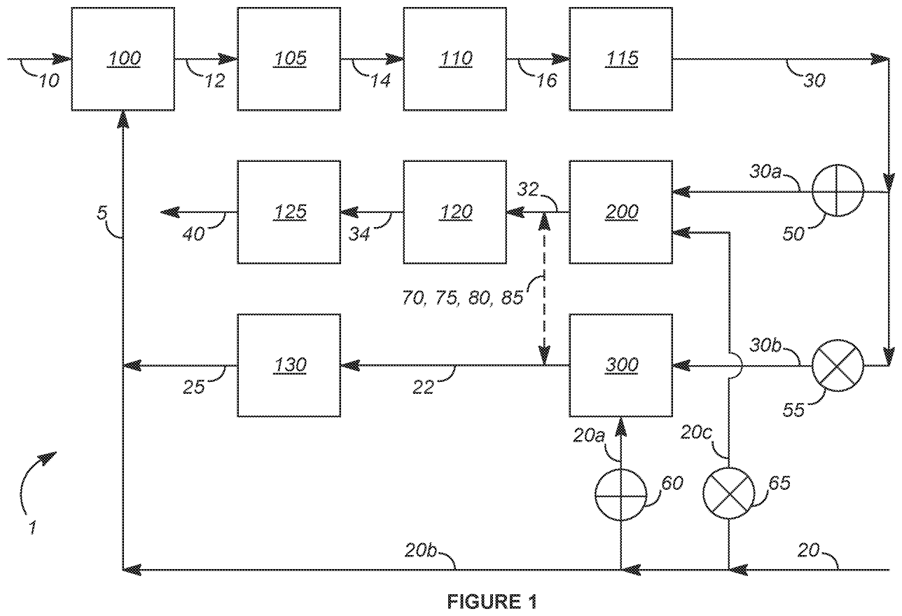

### FIELD OF THE INVENTION

Aspects of the invention relate to gasification processes in which tars and oils in a gasifier effluent are effectively managed by adsorption using a solid adsorbent, thereby allowing for the recovery of a high quality synthesis gas product. Further aspects relate to the manner of utilization, replacement, and/or regeneration of the solid adsorbent, such as to achieve additional process integration objectives.

### DESCRIPTION OF RELATED ART

The gasification of coal has been performed industrially for over a century in the production of synthesis gas (syngas) that can be further processed into transportation fuels. More recent efforts toward developing energy independence with reduced greenhouse gas emissions have led to a strong interest in using biomass as a gasification feed, and thereby an alternative potential source of synthesis gas, as well as its downstream conversion products. These include renewable natural gas (RNG) or biomethane, in addition to higher molecular weight hydrocarbons.

Generally, biomass gasification is performed by partial oxidation in the presence of a suitable oxidizing gas containing oxygen and other possible components such as steam. Gasification at elevated temperature and pressure, optionally in the presence of a catalytic material, produces an effluent with hydrogen and oxides of carbon (CO, CO₂), as well as hydrocarbons such as methane. This effluent, which may be referred to as syngas in view of its H₂ and CO content, is normally treated to remove a number of undesired components that can include particulates, alkali metals, and sulfur compounds. Such treatment steps may be necessary to render the gasifier effluent/synthesis gas product suitable for downstream conversion of the significant concentrations of H₂ and CO/CO₂ to value-added products, such as higher molecular weight hydrocarbons and/or alcohols of varying carbon numbers via Fischer-Tropsch conversion or RNG via catalytic methanation that increases the methane content in a resulting RNG stream.

Also undesired in the gasifier effluent is the presence, at concentrations ranging from several parts per million (ppm) to several percent by weight, of heavier molecules that are generally referred to as tars and oils. Similar to the synthesis gas contaminants noted above, tars and oils interfere with subsequent processing steps utilizing catalysts that perform optimally (e.g., from the standpoint of stability) with pure feed gases. In addition, these byproducts of gasification pose significant challenges in terms of their tendency to condense from the vapor phase onto lower-temperature surfaces encountered downstream of the gasifier, including those of apparatuses used for upgrading of synthesis gas to end products. Physical deposition of tars and oils is known to cause fouling/clogging of process lines, valves, reactors, and other equipment.

In view of these considerations, the art has adopted a number of approaches with the objective of removing tars and oils, downstream of the gasifier in which they are produced as detrimental byproducts. One prevailing technique involves passing the gasifier effluent through a liquid medium such as bio-oil liquor to scrub this effluent of tars and oils (based on their preferential solubility), followed by combusting this liquor, after it has become spent, thereby emitting flue gases CO₂. Oil washing systems, while effective at reducing the content of tars and oils in synthesis gas to very low levels, are complex operations in which the management of moisture, as well as fresh and spent oil, present a number of technical and economic challenges.

Alternative methods, which avoid the separate emissions that result from regeneration of tar-saturated oil, rely on catalytic or thermal treatment of tar-and oil-laden synthesis gas to directly convert the higher molecular weight byproducts to synthesis gas constituents during normal operation. Catalytic processes, however, require additional steam and/or oxygen reactants, and known catalysts for this conversion not only are quite susceptible to coking that limits operating life, but also require expensive catalytic metals that can become readily deactivated (poisoned) by even trace impurities such as sulfur. The operation of a catalytic tar/oil conversion reactor is complicated by the presence of solid particles (e.g., ash) entrained in the synthesis gas, and such operation therefore requires either upstream filtration or special adaptations to pass particles. These and other difficulties associated with removing tars and oils by catalytic destruction are evidenced by the fact this technology is currently not offered with commercial performance guarantees. In general, present attempts to implement catalytic conversion of tars and oils have proven to be uneconomical and/or technically unfeasible.

Thermal methods for decomposition of tars and oils involve subjecting the tar-and oil-laden synthesis gas to very high temperatures in the presence of additional oxygen that is input downstream of the gasifier. Significant issues arising from these combustive approaches, which must be addressed in a satisfactory manner, are heat recovery and synthesis gas cooling. For example, due to the generation of process temperatures that are sufficient to melt biomass ash and other solid particles emanating from the gasifier that may be present in the synthesis gas, a complex and expensive heat exchange system is required to cool the syngas without causing molten ash and bed materials to coat heat exchange surfaces or damage protective refractory linings within vessels. Further disadvantages of thermal destruction of tars and oils, beyond these special equipment requirements, include the consumption of syngas that reduces overall product yield, together with the substantial incremental oxygen requirement, in excess of the theoretical amount needed for gasification alone. Each of these characteristics has an adverse impact on process economics.

The present state of the art would benefit substantially from effective solutions to the problem of removing tars and oils from a gasifier effluent, or synthesis gas product, which overcome disadvantages of known techniques as described above. These byproducts, which are derived from a variety of carbonaceous feeds (e.g., coal and biomass) that are processed by gasification, significantly complicate downstream operations including compression, heat transfer, and the conversion of syngas into value-added products and chemicals.

### SUMMARY OF THE INVENTION

Aspects of the invention are associated with the discovery of gasification processes in which tars and oils present in the gasifier effluent (gasifier effluent tar) are effectively removed by adsorption onto a solid adsorbent, or “trapped.” In some cases, this expedient solution can advantageously allow for the controlled management of the adsorbed tars and oils, particularly in terms of (i) how this material may be “positioned” within the overall process and/or (ii) the conditions to which this material may be subjected, in order to derive important benefits. These include improved process integration, with the ability to recover and monetize hydrogen and carbon values of the adsorbed tars and oils and/or reduce CO₂ output compared to conventional strategies. Further advantages reside in the potential avoidance of added process inputs for, and consumption of, oxygen and steam required for known processing steps such as catalytic conversion and spent liquid adsorbent combustion, as noted above.

Other aspects relate to solid adsorbents that comprise a tar adsorptive material, such as a high surface area acidic material, through which a gasifier effluent may be passed to promote the adsorptive trapping of tars and oils in this effluent and provide a tar-depleted or essentially tar-free synthesis gas. Depending on particular tar adsorption conditions, adsorptive trapping may be accompanied by a limited (partial) or substantial degree of chemical transformation of tars and oils, including conversion to condensed coke that is retained with the solid adsorbent and/or conversion to components of the synthesis gas (e.g., additional H₂ and/or CO). Any of such transformation(s) nonetheless result in the effective removal of tars and oils from the synthesis gas, possibly with the added benefit of increasing its yield. Suitable tar adsorptive materials described herein possess requisite physical and chemical properties necessary to bind tars and oils for extended periods of operation, under the high temperatures that are characteristic of gasifier effluents, optionally following some degree of cooling. These properties include sufficient surface area, acidity, structural integrity, attrition resistance, thermal stability, and regenerability.

Further aspects relate to the regeneration of these solid adsorbents following a period of normal operation or service, over which sufficient utilization results in lost adsorption capacity and/or deactivation with respect to desired chemical transformations. The need for regeneration of such “spent” solid adsorbent will generally arise from the deposition of tars and oils, optionally in combination with their further conversion to condensed coke and other carbonaceous products that, like the tars and oils themselves, remain with the solid adsorbent and thereby become segregated from the flowing synthesis gas product. In the case of conversion, the chemical transformation pathways generally proceed on the surface of the solid adsorbent, but these reactions, as well as the initial adsorption of the tars and oils, can likewise occur within pores of the solid adsorbent.

More particular aspects relate to the handling of the spent adsorbent and namely the ability to change or shift its “position,” in terms of the overall flows and equipment of the process, followed by integrating its regeneration into the process, at a different position and/or under different conditions that provide important benefits. According to specific embodiments, normal operation or service of the solid adsorbent can occur downstream of the gasifier, whereas regeneration of spent adsorbent can occur upstream of the gasifier. The terms “upstream” and “downstream” relate to the general flow of gases from the gasifier feed to the gasifier effluent and through other parts of a gasification process. Those skilled in the art, having knowledge of the present disclosure, will readily understand the meanings of these terms, as well as understand that a change or shift in position of solid adsorbent (e.g., fresh adsorbent, spent adsorbent, or regenerated adsorbent) does not necessarily require a change in its physical location, but can be achieved using appropriate piping/valves for manipulating process flows.

For example, a tar adsorber containing solid adsorbent and placed in normal operation or service can be isolated, or removed from such normal operation or service, optionally together with other components of a larger tar adsorber subsystem, after a period of sufficient utilization that results in the solid adsorbent becoming spent solid adsorbent and requiring regeneration in order to once again achieve satisfactory adsorptive performance. This tar adsorber may then be contacted with a different process stream, effectively changing its position within the process, under different conditions, such as regeneration conditions as opposed to tar adsorption conditions. In one representative embodiment the process stream for regeneration, i.e., for contacting with the spent adsorbent under regeneration conditions, may comprise predominantly a mixture of H₂O, CO₂, O₂, and/or may comprise all or a portion of these components that are subsequently provided to the gasifier, to the extent these components are not converted under the regeneration conditions. In this manner, the tar adsorber and spent adsorbent may be positioned upstream of the gasifier, for purposes of regeneration. This regeneration may involve a net production of CO₂ due to combustion/oxidation of adsorbed tars and oils and/or their further conversion products as described above. However, by virtue of the regeneration being performed upstream of the gasifier, some or all of this CO₂ and other components of the regeneration effluent may be processed in the gasifier and at least partially converted, for example to an equilibrium amount of CO as a result of the water-gas shift (WGS) reaction. Such capture and utilization of CO₂ to increase the yield of the synthesis gas contrasts with conventional processes that discharge CO₂ present in flue gases to the atmosphere, optionally following combustion of the flue gases (e.g., flaring).

The routing of a regeneration effluent to the gasifier may be achieved by performing the regeneration at a pressure higher than that of the gasifier, for example by utilizing a source of pressurized steam for input to the vessel containing solid adsorbent being regenerated upstream of the gasifier. This can optionally avoid the need for a compressor between this vessel and the gasifier, while realizing the benefits of thermal efficiency (e.g., recovery of regeneration heat, such as for input/use in the gasifier), in addition to CO₂ capture and utilization as described above. Strategies for integration include diverting at least a portion of a makeup gas composition that is a component of the oxygen-containing gasifier feed, such as a fresh gasifier feed (e.g., comprising H₂O, CO₂, O₂), to the vessel used for regeneration of spent adsorbent, and/or the use of at least a portion of the regeneration effluent as a component of the oxygen-containing gasifier feed. Such strategies, for performing regeneration in an efficient manner using readily available gas compositions and for the recovery of heat and carbon content (e.g., as CO₂) in regeneration effluents, apply not only to solid adsorbents but also to liquid absorbents as well as solid catalysts, any of which may be used for tar remediation in gasification processes.

Embodiments of the invention are directed to processes for the gasification of a carbonaceous feed (e.g., coal or biomass) to produce a synthesis gas product. Representative processes comprise, in a gasifier, contacting the carbonaceous feed with an oxygen-containing gasifier feed under gasification conditions to provide a gasifier effluent comprising gasifier effluent tar. Such processes further comprise, in a tar adsorber, contacting at least a portion of the gasifier effluent with at least a first bed of a solid adsorbent, under tar adsorption conditions, to adsorb at least a portion of the gasifier effluent tar to provide a tar adsorber effluent having a reduced amount of tar. In some embodiments, the tar adsorber effluent may equate to the synthesis gas product. In other embodiments, representative processes may further comprise recovering the synthesis gas product from the tar adsorber effluent, for example following one or more additional process steps such as cooling and/or purifying (e.g., scrubbing to remove acid gases such as CO₂) the tar adsorber effluent.

More particular embodiments comprise replacing all or a portion of the first bed of the solid adsorbent, based on an indication of sufficient utilization (e.g., a time of operation) that results in the solid adsorbent becoming spent solid adsorbent. For example, the first bed of solid adsorbent may be replaced with a second bed of the solid adsorbent that is a bed of fresh adsorbent (not having been used for tar adsorption) or a bed of regenerated solid adsorbent (having been used for tar adsorption, but following a subsequent regeneration). The step of “replacing” is meant to encompass a physical replacement of solid adsorbent contained within a vessel such as a tar adsorber. This term is also meant to encompass the re-routing of process flows, such that a vessel, which may be a first, “in-service” tar adsorber containing the first bed of solid adsorbent, is effectively “removed” from a tar adsorption operation and “replaced,” in view of the re-routed process flows, with a different vessel, which may be a second, “regenerating” tar adsorber containing the second bed of solid adsorbent. Optionally, such second tar adsorber, may, in turn, be effectively removed from a regeneration operation and replaced, in view of the re-routed process flows, with the first tar adsorber.

In this manner, representative processes may include at least two tar adsorbers, for example operating simultaneously for over at least a portion of a period in which synthesis gas is produced, with one tar adsorber being in service for tar adsorption from the gasifier effluent and another tar adsorber for regenerating spent adsorbent. The tar adsorbers may be alternated between positions characteristic of an in-service tar adsorber (e.g., downstream of the gasifier) and a regenerating tar adsorber (e.g., upstream of the gasifier), by re-routing process flows. The tar adsorbers will generally each contain the same type of solid adsorbent, although it is possible for different types of solid adsorbent to be used in the different tar adsorbers. Different types of solid adsorbent may alternatively be used in a single tar adsorber (e.g., in separate fixed beds within such tar adsorber), or otherwise in a serial arrangement of adsorbers, each containing a different type of solid adsorbent (e.g., with the different types being selective for adsorption of different, specific compounds, or classes of compounds, present in the gasifier effluent). Effective and advantageous process integration may be achieved, according to specific embodiments in which regeneration, carried out in the regenerating tar adsorber containing the second bed of solid adsorbent, comprises contacting a first portion of a fresh gasifier feed, as described herein, with this bed, and the oxygen-containing gasifier feed comprises a second portion of the fresh gasifier feed. Alternatively, or in combination, the oxygen-containing gasifier feed may comprise at least a portion of the regeneration effluent provided from regeneration of the second bed of solid adsorbent under regeneration conditions. This regeneration effluent may, more particularly, comprise CO, CO₂, H₂O and/or H₂ resulting from oxidation, cracking, and/or reforming of tars and oils and/or their further conversion products as described above, having been adsorbed from the gasifier effluent, onto the second bed of solid adsorbent when the tar adsorber containing this bed was previously in a position characteristic of an in-service tar adsorber.

Other more particular embodiments are directed to processes for gasification of a carbonaceous feed, with such processes being integrated with tar adsorption and solid adsorbent regeneration. The processes comprise, in a gasifier, contacting the carbonaceous feed with an oxygen-containing gasifier feed, under gasification conditions, to provide a gasifier effluent comprising gasifier effluent tar. The processes further comprise alternating first and second beds of a solid adsorbent between (i) tar adsorption, by contact with the gasifier effluent under tar adsorption conditions, to adsorb at least a portion of the gasifier effluent tar and provide a tar adsorber effluent having a reduced amount of tar, and (ii) regeneration, by contact with a first portion of a fresh gasifier feed under regeneration conditions, to oxidize, crack, and/or reform at least a portion of adsorbed tar to CO, CO₂, H₂O and/or H₂ to provide a regeneration effluent. In some embodiments, the tar adsorber effluent may equate to the synthesis gas product. In other embodiments, representative processes may further comprise recovering the synthesis gas product from the tar adsorber effluent, for example following one or more additional process steps such as cooling and/or purifying (e.g., scrubbing) the tar adsorber effluent. Effective and advantageous process integration may be achieved, according to specific embodiments in which the oxygen-containing gasifier feed comprises (i) a second portion of the fresh gasifier feed, and/or (ii) at least a portion of the regeneration effluent.

Further embodiments are directed to analogous processes, as described in greater detail below, in which, as an alternative to tar adsorption, tar conversion is integrated with gasification to achieve the same or analogous advantages, particularly with respect to such processes being further integrated with the regeneration of a solid catalyst used for the tar conversion.

These and other embodiments, aspects, and advantages relating to the present invention are apparent from the following Detailed Description.

### BRIEF DESCRIPTION OF THE DRAWING

A more complete understanding of the exemplary embodiments of the present invention and the advantages thereof may be acquired by referring to the following description in conjunction with the accompanying Figure.

The Figure depicts a flowscheme illustrating a specific embodiment of a process for the gasification of a carbonaceous feed, in which tar adsorption is carried out by contacting a gasifier effluent with a first bed of solid adsorbent contained in a first tar adsorber. This process is integrated with regeneration of a second bed of solid adsorbent contained in a second tar adsorber, and utilizes appropriate piping/valves for manipulating process flows, such that the first and second tar adsorbers, and their respective beds of solid adsorbent, can be alternated between positions and functions of tar adsorption and regeneration.

In order to facilitate explanation and understanding, the Figure provides a simplified overview. Some associated equipment such as vessels, heat exchangers, valves, instrumentation, and utilities, is not shown, as its specific description is not essential to the implementation or understanding of the various aspects of the invention. Such equipment would be readily apparent to those skilled in the art, having knowledge of the present disclosure. Other processes for producing a synthesis gas product according to other embodiments within the scope of the invention, having configurations and constituents determined, in part, according to particular processing objectives, would likewise be apparent.

### DETAILED DESCRIPTION

The expressions “wt-%” and “mol-%,” are used herein to designate weight percentages and molar percentages, respectively. The expressions “wt-ppm” and “mol-ppm” designate weight and molar parts per million, respectively. For ideal gases, “mol-%” and “mol-ppm” are equal to percentages by volume and parts per million by volume, respectively.

The term “substantially,” as used herein, refers to an extent of at least 95%. For example, the phrase “substantially all” may be replaced by “at least 95%.” The phrase “at least a portion” is meant to encompass, in certain embodiments, “at least 50% of,” “at least 75% of,” “at least 90% of,” and, in preferred embodiments, “all.”

Embodiments of the present invention are directed to processes for gasification of a carbonaceous feed to produce a synthesis gas product. Representative processes comprise contacting the carbonaceous feed in a gasifier with an oxygen-containing gasifier feed under gasification conditions to provide a gasifier effluent comprising gasifier effluent tar, at least a portion of which is adsorbed by contacting of the gasifier effluent with a solid adsorbent. The term “gasifier effluent tar” is meant encompass compounds that are referred to in the art as “tars” and “oils” and that include hydrocarbons and oxygenated hydrocarbons having molecular weights greater than that of methane and being present in effluent gases produced from the gasification of coal and biomass. Certain types of these compounds, having relatively high molecular weight, are further characterized by being problematic due to their tendency to condense and coat internal surfaces of processing equipment, downstream of the gasifier, creating problems relating to fouling, corrosion, and/or plugging. Other types of these compounds, such as ethane, ethylene, and acetylene, will not condense from the gasifier effluent but will nonetheless “tie up” hydrogen and carbon, with the effect of reducing the overall yield of H₂ and CO as the desired components of synthesis gas. In general, “gasifier effluent tar” is meant to include at least hydrocarbons and oxygenated hydrocarbons having six carbon atoms or more (C₆⁺ hydrocarbons and oxygenated hydrocarbons), with benzene, toluene, xylenes, naphthalene, phenol, and cresols being specific examples.

In the case of “gasifier effluent tar” that has been adsorbed onto the surface, or within the pores, of a solid adsorbent as described herein, this term is meant to encompass not only the compounds described above, but also the further conversion products of these compounds, such as condensed coke and other carbonaceous products that remain with the solid adsorbent and thereby become segregated from the flowing synthesis gas product. Upon regeneration of the solid adsorbent, such further conversion products, like the tars and oils themselves, can be oxidized, cracked, and/or reformed to provide, in the regeneration effluent, CO, CO₂, H₂O, and/or H₂ that may be beneficially returned to, and utilized in, the overall process.

### Solid Adsorbents for Adsorption of Gasifier Effluent Tar

Representative solid adsorbents comprise a tar adsorptive material that imparts suitable physical and chemical properties for effective adsorptive performance under conditions, including high temperatures, which are characteristic of gasifier effluents. These properties can include a sufficient surface area for adsorption, such as generally at least about 10 m²/g (e.g., from about 10 m²/g to about 300 m²/g), typically at least about 50 m²/g (e.g., from about 50 m²/g to about 250 m²/g), and often at least about 100 m²/g (e.g., from about 100 m²/g to about 200 m²/g). In some embodiments, these surface areas may be representative of the solid adsorbent as a whole. Surface area may be determined according to the BET (Brunauer, Emmett and Teller) method based on nitrogen adsorption (ASTM D1993-03(2008)).

Exemplary tar adsorptive materials include zeolites (zeolitic molecular sieves) and non-zeolitic molecular sieves (zeotypes), as well as amorphous solid materials such as amorphous aluminosilicates and amorphous metal oxides. Particular zeolites or non-zeolitic molecular sieves may have a structure type selected from the group consisting of CHA, TON, FAU, FER, BEA, ERI, MFI, MEL, MTW, MWW, MOR, LTL, LTA, EMT, MAZ, MEI, AFI, and AEI, and preferably selected from one or more of CHA, TON, FAU, FER, BEA, ERI, and MFI. The structures of zeolites having these and other structure types are described, and further references are provided, in Meier, W. M, et al., Atlas of Zeolite Structure Types, 4^{th} Ed., Elsevier: Boston (1996). Specific examples include SSZ-13 (CHA structure), zeolite Y (FAU structure), zeolite X (FAU structure), MCM-22 (MWW structure), zeolite beta (BEA structure), ZSM-5 (MFI structure), and ZSM-22 (TON structure), with zeolite beta and ZSM-5 being exemplary.

Non-zeolitic molecular sieves (zeotypes) include ELAPO molecular sieves which are embraced by an empirical chemical composition, on an anhydrous basis, expressed by the formula:

(ELₓAl_{y}P_{z})O₂

wherein EL is an element selected from the group consisting of silicon, magnesium, zinc, iron, cobalt, nickel, manganese, chromium and mixtures thereof, x is the mole fraction of EL and is often at least 0.005, y is the mole fraction of aluminum and is at least 0.01, z is the mole fraction of phosphorous and is at least 0.01 and x+y+z=1. When EL is a mixture of metals, x represents the total mole fraction of such metals present. The preparation of various ELAPO molecular sieves is known, and examples of synthesis procedures and their end products may be found in U.S. Pat. No. 5,191,141 (ELAPO); U.S. Pat. No. 4,554,143 (FeAPO); U.S. Pat. No. 4,440,871 (SAPO); U.S. Pat. No. 4,853,197 (MAPO, MnAPO, ZnAPO, CoAPO); U.S. Pat. No. 4,793,984 (CAPO); U.S. Pat. No. 4,752,651 and U.S. Pat. No. 4,310,440. Preferred ELAPO molecular sieves are SAPO and ALPO molecular sieves. Generally, the ELAPO molecular sieves are synthesized by hydrothermal crystallization from a reaction mixture containing reactive sources of EL, aluminum, phosphorus and a templating agent. Reactive sources of EL are the metal salts of EL elements defined above, such as their chloride or nitrate salts. When EL is silicon, a preferred source is fumed, colloidal or precipitated silica. Preferred reactive sources of aluminum and phosphorus are pseudo-boehmite alumina and phosphoric acid. Preferred templating agents are amines and quaternary ammonium compounds. An especially preferred templating agent is tetraethylammonium hydroxide (TEAOH).

A particular tar adsorptive material is an ELAPO molecular sieve in which EL is silicon, with such molecular sieve being referred to in the art as a SAPO (silicoaluminophosphate) molecular sieve. In addition to those described in U.S. Pat. Nos. 4,440,871 and 5,191,141, noted above, other SAPO molecular sieves that may be used are described in U.S. Pat. No. 5,126,308. Of the specific crystallographic structures described in U.S. Pat. No. 4,440,871, SAPO-34, i.e., structure type 34, represents a specific tar adsorptive material. The SAPO-34 structure (CHA structure) is characterized in that it adsorbs xenon but does not adsorb iso-butane, indicating that it has a pore opening of about 4.2 Å. Accordingly, a representative solid adsorbent may comprise SAPO-34 or other SAPO molecular sieve, such as SAPO-17, which is likewise disclosed in U.S. Pat. No. 4,440,871 and has a structure characterized in that it adsorbs oxygen, hexane, and water but does not adsorb iso-butane, indicative of a pore opening of greater than about 4.3 Å and less than about 5.0 Å. Without being bound by theory, the acidity of SAPO-34 is believed to promote the effective adsorption of gasifier effluent tar. According to particular embodiments, the solid adsorbent may comprise a zeolite (zeolitic molecular sieve) of ZSM-5 or SSZ-13 or a non-zeolitic molecular sieve (zeotype) of SAPO-34 or SAPO-17. With respect to any particular zeolite or non-zeolitic molecular sieve that may be used as a component of a solid adsorbent as described herein, this may be present in any form according to which ion exchange sites are in their hydrogen form or otherwise exchanged with a suitable cation, non-limiting examples of which are cations of alkali metals (e.g., Na⁺), cations of alkaline earth metals (e.g., Ca⁺²), and ammonium cation (NH₄⁺). For example, as a zeolite, hydrogen form SSZ-13 (HSSZ-13) may be used; as a non-zeolitic molecular sieve, hydrogen form SAPO-34 (HSAPO-34) may be used.

In the case of a solid adsorbent comprising a zeolite or a non-zeolitic molecular sieve, such solid adsorbent may be more particularly defined as a solid acid adsorbent, on the basis of the acidity exhibited by the zeolite or non-zeolitic molecular sieve. The acidity of a given zeolite or non-zeolitic molecular sieve may be determined, for example, by temperature programmed desorption (TPD) of a quantity of ammonia (ammonia TPD), from an ammonia-saturated sample of the material, over a temperature from 275 °C (527 °F) to 500 °C (932 °F), which is beyond the temperature at which the ammonia is physisorbed. The quantity of acid sites, in units of millimoles of acid sites per gram (mmol/g) of material, therefore corresponds to the number of millimoles of ammonia that is desorbed per gram of material in this temperature range. A representative zeolitic or non-zeolitic molecular sieve, or otherwise a representative tar adsorptive material or solid adsorbent, has at least about 15 μmol/g (e.g., from about 15 to about 75 μmol/g) of acid sites, or at least about 25 μmol/g (e.g., from about 25 to about 65 μmol/g) of acid sites, measured by ammonia TPD. In the case of zeolitic molecular sieves, acidity is a function of the silica to alumina (SiO_{2/}Al₂O₃) molar framework ratio, and, in embodiments in which the solid adsorbent comprises a zeolitic molecular sieve, its silica to alumina molar framework ratio may be less than about 60 (e.g., from about 1 to about 60), or less than about 40 (e.g., from about 5 to about 40).

Instead of, or optionally in combination with, one or more zeolites and/or one or more non-zeolitic molecular sieves, solid adsorbents may comprise, or may optionally further comprise, an amorphous aluminosilicate or a refractory metal oxide. Regarding the latter types of possible components of solid adsorbents, representative refractory metal oxides include those selected from the group consisting of aluminum oxide, silicon oxide, titanium oxide, zirconium oxide, magnesium oxide, calcium oxide, iron oxide, vanadium oxide, chromium oxide, nickel oxide, tungsten oxide, and strontium oxide. Exemplary solid adsorbents, and more particularly solid acid adsorbents, comprise such metal oxides being modified with sulfate ions, such as in the case of sulfated zirconia, or other solid acids including those conventionally used in the alkylation of hydrocarbons. In representative embodiments, solid adsorbents may comprise (a) one or more zeolitic molecular sieves (e.g., a single type of zeolitic molecular sieve) or (b) one or more non-zeolitic molecular sieves (e.g., a single type of non-zeolitic molecular sieve), with (a) or (b) optionally being in combination with (c) one or more refractory metal oxides (e.g., a single type of refractory metal oxide). In this case, (a) or (b), and optionally (c), may be present in an amount, or optionally a combined amount, of greater than about 75 wt-% (e.g., from about 75 wt-% to about 99.9 wt-%) or greater than about 90 wt-% (e.g., from about 90 wt-% to about 99 wt-%), based on the weight of the solid adsorbent. For example, according to more particular embodiments, (a) or (b) alone, such as in the specific case of a single type of zeolitic molecular sieve alone or a single type of non-zeolite molecular sieve alone, may be present in these representative amounts. However, in other embodiments, (c) alone may be present in these representative amounts. Other representative tar adsorptive materials include (i) one or more clays, such as naturally-occurring clays, including those categorized within the groups of kaolinite, illite, and montmorillonite, and/or (ii) one or more minerals, such as dolomite, olivine, and/or limestone. One or more clay(s) and/or one or more mineral(s) may likewise be present in these representative amounts, individually or in combination, based on the weight of the solid adsorbent.

According to some embodiments, the solid adsorbent may have little or no activity for the catalytic conversion of gasifier effluent tar, and more particularly for converting this tar, or its further conversion products, to CO, CO₂, H₂O, and/or H₂. Such embodiments relate to important advantages that may be attained if the solid adsorbent functions as a “poor” catalytic agent, or possibly even a non-catalytic agent, but nonetheless functions as an effective adsorptive agent. As described above, these advantages can result from overall simplification relative to processes that rely on the catalytic conversion of gasifier effluent tar, with associated (i) requirements for additional steam and/or oxygen reactant inputs, (ii) rapid catalyst deactivation due to sulfur and other trace heteroatoms in the carbonaceous feed, and (iii) other adaptations needed to accommodate a catalytic reactor that add complexity and costs. Further advantages relate to the ability to retain or “trap” tars and oils, and their further conversion products, for subsequent handling in controlled manner that may better preserve and utilize the carbon and hydrogen values from the carbonaceous feed (e.g., by increasing the yield of the synthesis gas).

Yet further advantages may be derived from the ability to avoid the use of expensive catalytic metals in the solid adsorbent formulation. For example, according to some embodiments, the solid adsorbent may comprise one or more metals (e.g., Ni, Co, Fe, and/or noble metals), having activity for catalytic conversion of the gasifier effluent tar under the tar adsorption conditions present in a tar adsorber containing the solid adsorbent, in an amount, or combined amount, of less than about 1 wt-%, less than about 0.5 wt-%, or less than about 0.1 wt-%, based on the solid adsorbent. For example, the solid adsorbent may comprise Ni in any of these amounts, may comprise Co in any of these amounts, may comprise Fe in any of these amounts, and/or may comprise Ni, Co, and Fe in combination, in any of these amounts. As additional examples, the solid adsorbent may comprise a noble metal (e.g., Pt) in any of these amounts, or may comprise two or more noble metals (e.g., Pt and Pd), in any of these amounts. Noble metals are understood in the art as referring to a class of metallic elements that are resistant to oxidation, encompassing Pt, Rh, Ru, Pd, Ag, Os, Ir, and Au. In other embodiments, the amount, or combined amount, of any metal(s) present in solid adsorbent, other than those metals present in a zeolite, a non-zeolitic molecular sieve, a metal oxide, and/or a clay, as components of the solid adsorbent, may be less than about 1 wt-%, less than about 0.5 wt-%, or less than about 0.1 wt-%, based on the solid adsorbent. Overall, a lack of one or more catalytic metals as components of a solid adsorbent may provide a compositional basis for distinguishing a solid adsorbent from a solid catalyst. Further performance-based distinctions and process flow-based distinctions are likewise described herein.

### Solid Catalysts for Conversion of Gasifier Effluent Tar

Having knowledge of the present disclosure, those skilled in the art will appreciate that certain aspects disclosed herein may be applicable to, and even advantageous when practiced in conjunction with, solid catalysts as an alternative to solid adsorbents. Such aspects are more particularly based on the ability to apply the principles described herein that relate to the integration of solid adsorbent regeneration with gasification, to the integration of solid catalyst regeneration with gasification.

For example, specific embodiments of the invention are directed to processes for gasification of a carbonaceous feed to produce a synthesis gas product, the processes comprising contacting the carbonaceous feed in a gasifier with an oxygen-containing gasifier feed under gasification conditions to provide a gasifier effluent comprising gasifier effluent tar. The processes further comprise, in a tar conversion reactor, contacting at least a portion of the gasifier effluent with at least a first bed of a solid catalyst, under tar conversion conditions, to convert at least a portion of the gasifier effluent tar and provide a reactor effluent having a reduced amount of tar. The processes further comprise recovering the synthesis gas product from the reactor effluent. Based on an indication of sufficient utilization, at least a portion of the first bed of the solid catalyst may be replaced with at least a portion of a second bed of the solid catalyst, following a regeneration of the second bed of the solid catalyst. This regeneration may comprise contacting a first portion of a fresh gasifier feed with the second bed of the solid catalyst under regeneration conditions to provide a regeneration effluent comprising CO, CO₂, H₂O, and/or H₂ resulting from oxidation, cracking, and/or reforming of adsorbed tar and catalyst coke. Effective and advantageous process integration may be achieved, according to specific embodiments in which the oxygen-containing gasifier feed comprises a second portion of the fresh gasifier feed. Alternatively, or in combination, the oxygen-containing gasifier feed may comprise at least a portion of the regeneration effluent provided from regeneration of the second bed of solid catalyst under regeneration conditions.

Other specific embodiments of the invention are directed to processes for gasification of a carbonaceous feed, with such processes being integrated with tar conversion and solid catalyst regeneration. The processes comprise, in a gasifier, contacting the carbonaceous feed with an oxygen-containing gasifier feed, under gasification conditions, to provide a gasifier effluent comprising gasifier effluent tar. The processes further comprise alternating first and second beds of a solid catalyst between (i) tar conversion, by contact with the gasifier effluent under tar conversion conditions, to convert at least a portion of the gasifier effluent tar and provide a reactor effluent having a reduced amount of tar, and (ii) regeneration, by contact with a first portion of a fresh gasifier feed under regeneration conditions, to oxidize, crack, and/or reform at least a portion of adsorbed tar and catalyst coke to CO, CO₂, H₂O and/or H₂ to provide a regeneration effluent. In some embodiments, the reactor effluent may equate to the synthesis gas product. In other embodiments, representative processes may further comprise recovering the synthesis gas product from the reactor effluent, for example following one or more additional process steps such as cooling and/or purifying (e.g., scrubbing) the reactor effluent. Effective and advantageous process integration may be achieved, according to specific embodiments in which the oxygen-containing gasifier feed comprises (i) a second portion of the fresh gasifier feed, and/or (ii) at least a portion of the regeneration effluent.

In this manner, embodiments of the invention are directed to any of the gasification processes described herein, being integrated with regeneration, whether this is solid adsorbent regeneration or solid catalyst regeneration. Accordingly, with respect to any of the processes described herein that include steps of gasification (in a gasifier) and tar adsorption (in a tar adsorber), also disclosed are processes in which “tar adsorber” is replaced with “tar conversion reactor,” “tar adsorption” is replaced with “tar conversion,” “solid adsorbent” is replaced with “solid catalyst,” “tar adsorption conditions” is replaced with “tar conversion conditions,” “to adsorb” is replaced with “to convert,” “tar adsorber effluent” is replaced with “reactor effluent,” and/or “adsorbed tar” is replaced with “adsorbed tar and catalyst coke.” With respect to any of these disclosed processes comprising gasification (in a gasifier) and tar conversion (in a tar conversion reactor), unless specified to the contrary, any of the conditions (e.g., gasification temperature), stream compositions (e.g., synthesis gas product composition), processing steps (e.g., centrifugation, filtration), performance parameters (e.g., tar remaining in the synthesis gas product), and operating criteria (e.g., the indication of sufficient utilization) as described with respect to processes comprising gasification and tar adsorption, are likewise applicable.

Exemplary solid catalysts may be the same, in one or more respects, such as with respect to surface area, acidity, and/or composition, to solid adsorbents as described above. For example, with respect to composition, solid catalysts may comprise (a) one or more zeolitic molecular sieves (e.g., a single type of zeolitic molecular sieve) or (b) one or more non-zeolitic molecular sieves (e.g., a single type of non-zeolitic molecular sieve), with (a) or (b) optionally being in combination with (c) one or more refractory metal oxides (e.g., a single type of refractory metal oxide). In this case, (a) or (b), and optionally (c), may be present in an amount, or optionally a combined amount, of greater than about 75 wt-% (e.g., from about 75 wt-% to about 99.9 wt-%) or greater than about 90 wt-% (e.g., from about 90 wt-% to about 99 wt-%), based on the weight of the solid catalyst. For example, according to more particular embodiments, (a) or (b) alone, such as in the specific case of a single type of zeolitic molecular sieve alone or a single type of non-zeolite molecular sieve alone, may be present in these representative amounts. However, in other embodiments, (c) alone may be present in these representative amounts. Other representative components of solid catalysts include (i) one or more clays, such as naturally-occurring clays, including those categorized within the groups of kaolinite, illite, and montmorillonite, and/or (ii) one or more minerals, such as dolomite, olivine, and/or limestone. One or more clay(s) and/or one or more mineral(s) may likewise be present in these representative amounts, individually or in combination, based on the weight of the solid catalyst.

According to some embodiments, a given solid catalyst may be the same in all respects to a given solid adsorbent as described above, with the exception that the solid catalyst may comprise one or more metals (e.g., Ni, Co, Fe, and/or noble metals) having activity for catalytic conversion of the gasifier effluent tar, under the tar conversion conditions present in a tar conversion reactor containing the solid catalyst. For example, such one or more metals may be present in a solid catalyst in an amount, or combined amount, of generally from about 1 wt-% to about 20 wt-%, typically from about 2 wt-% to about 15 wt-%, and often from about 2 wt-% to about 10 wt-%. For example, the solid catalyst may comprise Ni in any of these amounts, may comprise Co in any of these amounts, may comprise Fe in any of these amounts, and/or may comprise Ni, Co, and Fe in combination, in any of these amounts. As additional examples, the solid catalyst may comprise a noble metal (e.g., Pt) in any of these amounts, or may comprise two or more noble metals (e.g., Pt and Pd) in any of these amounts.

### Further Exemplary Embodiments of Gasification Processes

The Figure depicts a flowscheme illustrating specific embodiments of a process according to which gasification in gasifier 100 is integrated with tar adsorption in tar adsorber 200 containing a solid adsorbent as described herein, to produce synthesis gas product 40. As noted above, according to other embodiments, tar adsorption may alternatively be tar conversion, being carried out in tar conversion reactor 200 containing a solid catalyst as described herein.

With respect to the use of tar adsorber 200 in exemplary processes for gasification of carbonaceous feed 10 to produce synthesis gas product 40, this carbonaceous feed may comprise coal (e.g., high quality anthracite or bituminous coal, or lesser quality subbituminous, lignite, or peat), petroleum coke, asphaltene, and/or liquid petroleum residue, or other fossil-derived substance. In a preferred embodiment, the carbonaceous feed may comprise biomass. The term “biomass” refers to renewable (non-fossil-derived) substances derived from organisms living above the earth's surface or within the earth's oceans, rivers, and/or lakes. Representative biomass can include any plant material, or mixture of plant materials, such as a hardwood (e.g., whitewood), a softwood, a hardwood or softwood bark, lignin, algae, and/or lemna (sea weeds). Energy crops, or otherwise agricultural residues (e.g., logging residues) or other types of plant wastes or plant-derived wastes, may also be used as plant materials. Specific exemplary plant materials include corn fiber, corn stover, and sugar cane bagasse, in addition to “on-purpose” energy crops such as switchgrass, miscanthus, and algae. Short rotation forestry products, such as energy crops, include alder, ash, southern beech, birch, eucalyptus, poplar, willow, paper mulberry, Australian Blackwood, sycamore, and varieties of paulownia elongate. Other examples of suitable biomass include vegetable oils, carbohydrates (e.g., sugars), organic waste materials, such as waste paper, construction, demolition wastes, digester sludge, and biosludge. Representative carbonaceous feeds therefore include, or comprise, any of these types of biomass. Particular carbonaceous feeds comprising biomass include municipal solid waste (MSW) or products derived from MSW, such as refuse derived fuel (RDF). Carbonaceous feeds may comprise a combination of fossil-derived and renewable substances, including those described above.

In gasifier 100 (or, more particularly, a gasification reactor of this gasifier), carbonaceous feed 10 is subjected to partial oxidation in the presence of oxygen-containing gasifier feed 5 in an amount that this generally limited to supply only 20-70% of the oxygen that would be necessary for complete combustion. Oxygen-containing gasifier feed will generally comprise other oxygenated gaseous components including H₂O and/or CO₂ that may likewise serve as oxidants of carbonaceous feed 10. Oxygen-containing gasifier feed 5 can refer to all gases being fed or added to gasifier 100, whether or not combined upstream of, or within, the gasifier. For example, oxygen-containing gasifier feed 5 may comprise at least a portion of a regeneration effluent (e.g., cooled regeneration effluent 25 as shown in the Figure) and/or at least a portion of a fresh gasifier feed (e.g., second portion 20b of fresh gasifier feed 20 as shown in the Figure). In gasifier 100, contacting of carbonaceous feed 10 with oxygen-containing gasifier feed 5 under gasification conditions provides a gasifier effluent. One or more reactors (e.g., operating in series or parallel) of gasifier 100 may operate under gasification conditions present in such reactor(s), with these conditions including a temperature of generally from about 500 °C (932 °F) to about 1000 °C (1832 °F), and typically from about 750 °C (1382 °F) to about 950 °C (1742 °F). Other gasifier conditions may include atmospheric pressure or elevated pressure, for example an absolute pressure generally from about 0.1 megapascals (MPa) (14.5 psi) to about 10 MPa (1450 psi), and typically from about 1 MPa (145 psi) to about 3 MPa (435 psi).

Other gasification reactor configurations include counter-current fixed bed (“up draft”), co-current fixed bed (“down draft”), and entrained flow plasma. Different solid catalysts, having differing activities for one or more desired functions in gasification, such as tar reduction, enhanced H₂ yield, and/or reduced CO₂ yield, may be used. Limestone may be added to a gasification reactor, for example, to promote tar reduction by cracking. Various catalytic materials may be used in a gasification reactor, including solid particles of dolomite, supported nickel, alkali metals, and alkali metal compounds such as alkali metal carbonates, bicarbonates, and hydroxides. Often, a gasifier is operated with a gasification reactor having a fluidized bed of particles of the carbonaceous feed (and optionally particles of solid catalyst), with the oxygen-containing gasifier feed, and optionally separate, fluidizing H₂O- and/or CO₂-containing feeds, being fed upwardly through the particle bed. Exemplary types of fluidized beds include bubbling fluidized beds and entrained fluidized beds.

In addition to gasifier effluent tar, this effluent comprises CO, CO₂, and methane (CH₄) that are derived from the carbon present in the carbonaceous feed, as well as H₂ and/or H₂O, and generally both, together with other components in minor concentrations, as described below. According to the embodiment illustrated in the Figure, untreated gasifier effluent 12 may be obtained as the gasifier effluent directly from gasifier 100, prior to any treatment steps as described herein.

Synthesis gas product 40 may comprise H₂ and CO in various amounts (concentrations), and preferably in a combined amount of greater than about 25 mol-% (e.g., from about 25 mol-% to about 95 mol-%), greater than about 50 mol-% (e.g., from about 50 mol-% to about 90 mol-%), or greater than about 65 mol-% (e.g., from about 65 mol-% to about 85 mol-%). These combined amounts may be on a water-free basis. With respect to any such combined amounts (concentrations), the H₂:CO molar ratio of the synthesis gas product may be suitable for use in downstream reactions as described above. These include the conversion to higher molecular weight hydrocarbons and/or alcohols of varying carbon numbers via Fischer-Tropsch conversion or RNG via catalytic methanation that increases the methane content in a resulting RNG stream. For example, the H₂:CO molar ratio of synthesis gas product 40, optionally following a water-gas shift (WGS) reaction and/or hydrogen addition to increase its hydrogen content, may be from about 0.5 to about 2.5, such as from about 1.0 to about 2.0. Independently of, or in combination with, the representative amounts (concentrations) of H₂ and CO above and/or representative H₂:CO molar ratios above, the synthesis gas product may comprise CO₂, for example in an amount of at least about 2 mol-% (e.g., from about 2 mol-% to about 30 mol-%), at least about 5 mol-% (e.g., from about 5 mol-% to about 25 mol-%), or at least about 10 mol-% (e.g., from about 10 mol-% to about 20 mol-%). Independently of, or in combination with, the representative amounts (concentrations) of H₂, CO, and CO₂ above and/or representative H₂:CO molar ratios above, the synthesis gas product may comprise CH₄, for example in an amount of at least about 0.5 mol-% (e.g., from about 0.5 mol-% to about 15 mol-%), at least about 1 mol-% (e.g., from about 1 mol-% to about 10 mol-%), or at least about 2 mol-% (e.g., from about 2 mol-% to about 8 mol-%). Together with any water vapor (H₂O), these non-condensable gases H₂, CO, CO₂, and CH₄ may account for substantially all of the composition of the synthesis gas product. That is, these non-condensable gases and any water may be present in synthesis gas product 40 in a combined amount of at least about 90 mol-%, at least about 95 mol-%, or even at least about 99 mol-%. The balance of the synthesis gas product may be all or substantially all non-reactive and/or inert gases such as N₂ and/or Ar.

With respect to any of these properties of synthesis gas product 40, in terms of its content of H₂, CO, CO₂, and/or CH₄ above and/or its representative H₂:CO molar ratios above, these may likewise apply, at least on a tar-free basis, to gasifier effluent 30 and/or upstream compositions of cleaned, cooled gasifier effluent 16, cleaned gasifier effluent 14, and/or untreated gasifier effluent 12. In this regard, it should be understood that operations performed by (i) centrifugation separator (e.g., cyclone) 105 on untreated gasifier effluent 12 to provide cleaned gasifier effluent 14, (ii) gasifier effluent cooler 110 on cleaned gasifier effluent 14 to provide cleaned, cooled gasifier effluent 16, and (iii) filter 115 on cleaned, cooled gasifier effluent 16 to provide gasifier effluent 30 (e.g., a “cleaned, cooled, filtered gasifier effluent” according to a specific embodiment) are optional operations, such that one of more of these may be omitted, depending on specific processing objectives (e.g., on the specific carbonaceous feed 10 being gasified). Accordingly, to the extent that processes described herein include the use of tar adsorber 200 to adsorb gasifier effluent tar from gasifier effluent 30, or otherwise include the use of tar conversion reactor 200 to convert this tar, any one of untreated gasifier effluent 12; cleaned gasifier effluent 14; or cleaned, cooled gasifier effluent 16 can likewise be input (used as a feed) to tar adsorber 200 or tar conversion reactor 200.

Aside from the content of H₂, CO, CO₂, and/or CH₄ above and/or representative H₂:CO molar ratios above, which apply to synthesis gas product 40 and/or gasifier effluent 30 in addition to any one or more of untreated gasifier effluent 12; cleaned gasifier effluent 14; and/or cleaned, cooled gasifier effluent 16, these streams may further comprise varying amounts of contaminants such as sulfur compounds (e.g., H₂S and/or COS), nitrogen compounds (e.g., NH₃), and solids (e.g., as solid particulates). In general, however, treatment steps may be used to reduce amounts of such contaminants in gasifier effluent 30, relative to untreated gasifier effluent 12. For example, gasifier effluent 30 may be obtained following one or more steps of removing the solids, such as those originally present in gasifier effluent 12 directly exiting gasifier 100. In a specific embodiment, these one or more steps may comprise a centrifugation step, such as in the case of using centrifugation separator (e.g., cyclone) 105 to remove relatively coarse particles, and a filtration step, such as in the case of using filter 115 to remove relatively fine particles. In this case, the centrifugation step and the filtration step may be performed upstream and downstream, respectively, of a step of cooling the gasifier effluent, such as in the case of using gasifier effluent cooler 110 or other system or apparatus for the cooling of, and/or recovery of heat from, the gasifier effluent (e.g., to generate high pressure steam).

Either or both of centrifugation separator 105 and filter 115 may be, in alternative embodiments, any suitable gas filtration and/or scrubbing operation for removal of solid particles (particulates) in a gasifier effluent. In the case of biomass gasification, these solid particles can include char, soot, and ash, any of which can generally contain alkali metals such as sodium. Corrosive and/or harmful species such as chlorides, arsenic, and/or mercury may also be contained in such particulates. A high temperature filtration, for example using bundles of metal or ceramic filters, may generally be sufficient to reduce the content of particulates in the gasifier effluent to less than 1 wt-ppm, and possibly less than 0.1 wt-ppm, upstream of (prior to) tar adsorber/tar conversion reactor 200, to promote its more effective operation. Downstream of (following) centrifugation separator 105, filter 115, and/or any such gas filtration and/or scrubbing operation, and upstream of (prior to) tar adsorber/tar conversion reactor 200, a supplemental cleaning operation may be used to further reduce the tar and overall hydrocarbon content of untreated gasifier effluent 12, for example by contact with a solid “polishing” material such as a carbon bed. This can provide for more thorough removal of benzene, naphthalene, toluene, phenols, and other condensable species that could otherwise be detrimental to downstream operations, such as by deposition onto equipment.

Whereas the above-described treatment steps, performed on untreated gasifier effluent 12 to obtain gasifier effluent 30 for subsequent contacting with a solid adsorbent or solid catalyst as described herein, are optional, it should also be understood that these treatment steps are also non-exhaustive. For example, other treatment steps as practiced in the art, to obtain gasifier effluent 30 such as those for the removal of sulfur compounds (e.g., utilizing a suitable guard bed such as an iron-or zinc oxide-containing material), for purification in other respects (e.g., scrubbing to remove acid gases such as CO₂) and/or for the adjustment of the H₂:CO molar ratio (e.g., utilizing a water-gas shift (WGS) reactor or hydrogen addition) may be used.

In the case of a treatment step for the removal of sulfur compounds, these may include, more particularly, H₂S, COS, and/or SO₂, contained in untreated gasifier effluent 12. Such compounds, which result from the presence of trace quantities of sulfur in carbonaceous feeds, including biomass, may be detrimental to (e.g., poison) catalysts used in tar conversion reactor 200 and/or those used in the conversion of the synthesis gas product to value-added products (e.g., higher molecular weight hydrocarbons and/or alcohols) as described above. Poisoning may result, for example, from the formation of metal sulfide compounds, such as nickel sulfide, at catalytically active metal sites, such as nickel sites, of the catalyst. A sulfur removal operation, according to a specific treatment step for the removal of sulfur compounds, may include contacting the gasifier effluent at any stage downstream of gasifier 100 and upstream of tar adsorber/tar conversion reactor 200, with a guard bed suitable to obtain a gasifier effluent 30 that is essentially free of sulfur, for example having less than 1 wt-ppm, such as less than 0.1 wt-ppm, of total sulfur. Suitable guard bed materials include those used in water treatment, such as iron-containing sorbent (iron “sponge”) materials and/or zinc oxide.

In the case of a treatment step for purification in other respects, an acid gas removal operation, for example, may be performed on the gasifier effluent at any stage downstream of gasifier 100 and upstream of tar adsorber/tar conversion reactor 200, to reduce the concentration of CO₂ and/or other acid gases (e.g., H₂S). An acid gas removal operation may utilize one or more stages of contacting with a physical solvent such as Selexol® (dimethyl ethers of polyethylene glycol), Rectisol® (cold methanol), or a combination thereof. One or more amine solvents such as monoethanolamine, diethanolamine, methyldiethanolamine, diisopropylamine, or diglycolamine, or otherwise methanol, potassium carbonate, a solution of sodium salts of amino acids, etc. can also be used to remove at least a portion of an acid gas initially present in untreated gasifier effluent 12. The gasifier effluent, following an acid gas removal operation and upstream of tar adsorber/tar conversion reactor 200, may have a CO₂ concentration generally from about 2 mol-% to about 40 mol-%, and typically from about 5 mol-% to about 20 mol-%, and may have a total sulfur concentration of less than about 0.1 mol-ppm. Alternatively, in the case of a treatment step for purification in other respects, an operation for the removal of water and water-soluble contaminants may be performed on the gasifier effluent at any stage downstream of gasifier 100 and upstream of tar adsorber/tar conversion reactor 200. For example, a wet scrubbing operation involving contacting the gasifier effluent with water (e.g., by performing co-current or counter-current contacting in a trayed column) may be effective for removing chlorides (e.g., in the form of HCl) and ammonia, as well as fine solid particles (e.g., char and ash).

In the case of a treatment step for the adjustment of the H₂:CO molar ratio, a specific example is a sour shift operation, which may be used to perform a WGS reaction in the presence of sulfur compounds, and thereby increase the concentration of H₂ (or the H₂:CO molar ratio) relative to that initially in the untreated gasifier effluent, as obtained from a gasifier. This operation may include one or more WGS reactors (e.g., operating in series or parallel) having a suitable catalyst that is resistant to deactivation in the presence of H₂S and/or COS, such as a cobalt-molybdenum catalyst. Other catalysts for this purpose include those based on copper-containing and/or zinc-containing catalysts, such as Cu—Zn—Al; chromium-containing catalysts; iron oxides; zinc ferrite; magnetite; chromium oxides; and any combination thereof (e.g., Fe₂O₃—Cr₂O₃ catalysts). Conditions for the catalytic WGS reaction may include a temperature from about 150 °C (302 °F) to about 400 °C (752 °F).

The optional inclusion of these specifically-described treatment steps and other treatment steps in processes within the scope of the present invention will depend on specific processing objectives (e.g., on the specific carbonaceous feed 10 being gasified). In general, such treatment steps may be performed at various stages of the overall process (e.g., upstream or downstream of the tar adsorber/tar conversion reactor 200) as needed to achieve these objectives. For example, (i) an operation for the removal of water and water-soluble contaminants (e.g., a wet scrubbing operation) and/or (ii) a treatment step for the adjustment of the H₂:CO molar ratio (e.g., a sour shift operation) may be performed downstream of the tar adsorber/tar conversion reactor. Certain treatment steps (e.g., a centrifugation step) may be performed in situ in gasifier 100 (e.g., using internal cyclones, for removal of solid particles, positioned in a headspace above a fluidized particle bed).

Regardless of any treatment steps used to obtain the gasifier effluent, particular aspects of the invention relate to the removal of tar in this effluent (gasifier effluent tar), by adsorption or catalytic conversion. For example, representative adsorptive processes, may comprise, in tar adsorber 200, contacting at least a portion of the gasifier effluent with at least a first bed of solid adsorbent (contained in the tar adsorber), under tar adsorption conditions, to provide tar adsorber effluent 32 having a reduced amount of tar (e.g., relative to the amount in the gasifier effluent). Tar adsorption conditions may include a temperature from about 400 °C (752 °F) to about 600 °C (1112 °C). Representative catalytic conversion processes may comprise, in tar conversion reactor 200, contacting at least a portion of the gasifier effluent with at least a first bed of solid catalyst (contained in the tar conversion reactor), under tar conversion conditions, to provide reactor effluent 32 having a reduced amount of tar (e.g., relative to the amount in the gasifier effluent). Depending on the activity of the solid catalyst, tar conversion conditions may include temperatures that are generally higher than those described above with respect to tar adsorption conditions, and may also be higher than those used in the gasifier. For example, these temperatures may in some cases be above 1000 °C (e.g., from about 1000 °C (1832 °F) to about 1500 °C (2732 °F), such as from about 1000 °C (1832 °F) to about 1250 °C (2282 °F)). The adsorption of tar, as performed in tar adsorber 200, does not preclude the possibility of at least some conversion of tar. Likewise, the conversion of tar, as performed in tar conversion reactor 200, does not preclude the possibility of at least some adsorption of tar and/or at least some conversion of methane (e.g., by reforming to yield additional components of synthesis gas).

Accordingly, it can be appreciated that, in preferred embodiments, a tar adsorber can be advantageously operated without external heating of this vessel. That is, the heat requirement of tar adsorber 200 may be obtained entirely from heat present in any of untreated gasifier effluent 12; cleaned gasifier effluent 14; cleaned, cooled gasifier effluent 16; or gasifier effluent 30 (e.g., a “cleaned, cooled, filtered gasifier effluent” according to a specific embodiment). This may contrast with the operation of a tar conversion reactor, requiring external heating, particularly in the case of operating above the temperature of gasifier 100. However, regardless of whether a solid adsorbent is utilized such that vessel 200 is a tar adsorber or a solid catalyst is utilized such that this vessel is a tar conversion reactor, in preferred embodiments process temperatures are maintained such that the condensation of any gasifier effluent tar is avoided in this vessel, as well as upstream of this vessel. For example, gasifier effluent 30, including any portion 30a thereof that is introduced to the tar adsorber or tar conversion reactor, may be maintained in this vessel, as well as from gasifier 100 to this vessel (e.g., in process lines or piping from an outlet of the gasifier to an inlet of the tar adsorber 200 or tar conversion reactor 200) at a temperature above a condensation temperature. This condensation temperature may correspond to that at which gasifier effluent tar (e.g., present in any of 12, 14, 16, or 30), or highest-boiling temperature component(s) of this tar, first condenses and may therefore also be referred to as the tar dewpoint. According to particular embodiments, the tar adsorber or tar conversion reactor, and/or process lines or piping, and optionally any equipment, from an outlet of the gasifier to an inlet of this vessel, may be maintained at a temperature of at least about 10 °C (18 °F), at least about 25 °C (45 °F), or at least about 50 °C (90 °F) above the condensation temperature, or tar dewpoint, of any of the gasifier effluent 12; cleaned effluent 14; and/or cleaned, cooled gasifier effluent 16. Having knowledge of the present disclosure, those skilled in the art can appreciate that a condensation temperature or tar dewpoint can be determined analytically, based on amounts or concentrations of CO, CO₂, H₂, and/or tar present in a given composition, optionally in combination with simulation tools that provide estimates of such temperatures. In terms of specific temperatures, according to particular embodiments, the tar adsorber or tar conversion reactor, and/or process lines or piping, and optionally any equipment, from an outlet of the gasifier to an inlet of this vessel, may be maintained at a temperature of at least about 300 °C (572 °F), at least about 400 °C (752 °F), or at least about 450 °C (842 °F).

Another distinction associated with the use of a tar adsorber compared to a tar conversion reactor is that, in the former operation, tar adsorber effluent 32, in the same manner as cooled tar adsorber effluent 34 (obtained following cooling) and cooled, scrubbed tar adsorber effluent 40 (e.g., the synthesis gas product obtained following cooling and scrubbing), may comprise substantially no tar conversion products. That is, in representative embodiments, the tar adsorber effluent may comprise no or substantially no CO, CO₂, and/or H₂ resulting from conversion of the gasifier effluent tar. For example, this effluent may comprise CO, CO₂, and/or H₂ in an amount representing less than about 10%, less than about 5%, or less than about 1%, conversion of the gasifier effluent tar. In some embodiments, the absence of conversion may be indicated by no or substantially no increase, or possibly no or substantially no change, in the amount(s) or concentration(s) of any one or more of these components across tar adsorber 200 (e.g., in tar adsorber effluent 32, relative to the gasifier effluent 30). For example, any change in tar adsorber effluent 32, relative to the gasifier effluent 30, may be solely due to tar adsorption, such that the tar concentration may be reduced in the former relative to the latter (e.g., may be absent or substantially absent in the former).

A further distinction associated with the use of a tar adsorber compared to a tar conversion reactor is that the former operation may advantageously avoid the requirement for additional steam and/or oxygen reactant inputs. In representative embodiments directed to tar adsorption processes, no supplemental source of steam and/or oxygen is added to tar adsorber 200 or upstream of tar adsorber 200, for example, added to gasifier effluent 30 or, more broadly, added at any point downstream of gasifier 100 up to tar adsorber 200, such as at any point from untreated gasifier effluent 12 up to tar adsorber 200.

According to particular embodiments, gasifier effluent 30, including any portion 30a thereof that is introduced to the tar adsorber or tar conversion reactor (depending on whether a solid adsorbent or solid catalyst is utilized) may comprise tar in an amount from about 0.01 wt-% to about 5 wt-%, such as from about 0.1 wt-% to about 3 wt-% or from about 0.5 wt-% to about 2 wt-%. Regardless of whether a solid adsorbent is utilized such that vessel 200 is a tar adsorber or a solid catalyst is utilized such that this vessel is a tar conversion reactor, tar adsorption or tar conversion may be effective to substantially or completely remove this gasifier effluent tar. For example, the tar adsorber effluent or reactor effluent exiting, respectively, the tar adsorber or tar conversion reactor, may comprise tar in an amount of less than about 0.5 wt-%, less than about 0.1 wt-%, or less than about 0.01 wt-%. Representative levels of tar adsorption or tar conversion, measured across the tar adsorber or tar conversion reactor, may be at least about 90%, at least about 95%, or even at least about 99%, resulting in a tar adsorber effluent or reactor effluent that may be substantially or completely free of tar.

Having knowledge of the present disclosure, those skilled in the art can determine the existence of tar conversion products, as well as determine percentages of gasifier effluent tar being adsorbed or converted, based on analyses of the compositions upstream and downstream of tar adsorber 200 or tar conversion reactor, including the amounts or concentrations of CO, CO₂, H₂, and/or tar present in these compositions.

Whether an adsorptive process is used to provide tar adsorber effluent 32 or a catalytic conversion process is used to provide reactor effluent 32, various treatment steps as described above for obtaining gasifier effluent 30 from untreated gasifier effluent 12 may likewise optionally be used for recovering synthesis gas product 40 from the tar adsorber effluent or the reactor effluent. For example, such treatment steps may be used for reducing amounts of contaminants (e.g., solids) as described above, cooling and/or recovering heat, removing sulfur compounds, purifying in other respects, and/or for adjusting of the H₂:CO molar ratio. In this regard, it can be appreciated that tar adsorber effluent/reactor effluent 32 may be referred to as untreated synthesis gas product 32, (i) from which synthesis gas product 40 is recovered, if treatment steps are performed, or (ii) to which synthesis gas product 40 may equate, in the absence of treatment steps. For example, synthesis gas product 40 may be recovered following one or more steps of cooling and/or scrubbing the tar adsorber effluent/reactor effluent 32. In a specific embodiment, a cooling step, such as in the case of using synthesis gas product cooler 120 or other system or apparatus for the cooling of, and/or recovery of heat from, the tar adsorber effluent/reactor effluent 32 (e.g., to generate high pressure steam) may be used to provide cooled synthesis gas product 34. Alternatively, or in combination, a scrubbing step, such as in the case of using synthesis gas scrubber 125 to remove acid gases such as CO₂ from untreated synthesis gas product 32 or cooled synthesis gas product 34 and provide synthesis gas product 40 as a cooled, scrubbed synthesis gas product.

In the case of tar adsorber 200 containing a first bed of solid adsorbent, according to representative adsorptive processes, or tar conversion reactor 200 containing a first bed of solid catalyst, according to representative catalytic conversion processes, such processes may further comprise replacing at least a portion of such first bed, based on (depending on) an indication of sufficient utilization of either the solid adsorbent or the solid catalyst. Such indication may be a time of operation, optionally in view of one or more process parameters, for example those that relate to the severity under which the solid adsorbent or solid catalyst perform. These parameters may include the type of carbonaceous feed, the gasification conditions, the amount of tar in the gasifier effluent, the temperature used for tar adsorption or tar conversion, or any combination of these parameters. An indication of sufficient utilization may also be a pressure drop across the tar adsorber 200 or tar conversion reactor 200, which may correspond to the pressure drop across the respective first bed of solid adsorbent or first bed of solid catalyst and may further correspond to the amount of adsorbed tar and/or catalyst coke present in the first bed material. An indication of sufficient utilization may also be a breakthrough of tar, such as tar observed or detected downstream of the tar adsorber 200 or tar conversion reactor 200, for example (i) as a condensate on process equipment or otherwise (ii) by analysis (e.g., of untreated synthesis gas product 32, cooled synthesis gas product 34, or synthesis gas product 40). An indication of sufficient utilization may also be a breakthrough of chloride (e.g., in the form of HCl) or ammonia, such as detected by analysis downstream of the tar adsorber 200 or tar conversion reactor 200. Any one or more of such indications of sufficient utilization may have an associated threshold value that when reached, forms the basis for replacing at least a portion of the first bed. For example, the indication of sufficient utilization may be (i) a time of operation reaching a threshold time of operation, (ii) a pressure drop reaching a threshold pressure drop, or (iii) a breakthrough of tar reaching a threshold breakthrough of tar. A combination of such indications, forming the basis for replacing at least a portion of the first bed, may also be used, such a combination of (i), (ii), and/or (iii), for example in the specific case of whichever of (i), (ii), or (iii) occurs first, or whichever of (i), (ii), or (iii) occurs last.

With respect to replacing at least a portion of the first bed of solid adsorbent or solid catalyst, based on an indication of sufficient utilization, this may involve, according to specific embodiments, replacing the entire bed or replacing the entire vessel (e.g., the tar adsorber or tar conversion reactor) containing this bed. The step of “replacing” can include the physical replacement of all or a portion of the first bed of solid adsorbent contained within the tar adsorber, or all or a portion of the first bed of solid catalyst contained with the tar conversion reactor, as the case may be. According to particular embodiments, at least a portion of the first bed of solid adsorbent contained within the tar adsorber, or at least a portion of the first bed of solid catalyst contained with the tar conversion reactor, may be replaced, respectively, with at least a portion of a second bed of solid adsorbent or at least a portion of a second bed of solid catalyst, following regeneration of such second bed, for example as described below. The physical replacement of solid adsorbent or solid catalyst can be accompanied by a period of cessation or shutdown of normal, “in-service” adsorptive or catalytic operation, as required to perform the replacement. As a practical alternative, however, the step of “replacing” may not require a period of cessation or shutdown, such as in the case of this step comprising the re-routing of process flows.

For example, the Figure depicts an arrangement of valves providing a “swing bed” configuration that allows vessels 200, 300 to be altered in their position, in terms of the overall flows and equipment of the process. Specifically, the positions and therefore the functions of a first, “in-service” tar adsorber 200 containing the first bed of solid adsorbent, or otherwise a first “in-service” tar conversion reactor 200 containing a first bed of solid catalyst, may be switched to that of a second “regenerating” tar adsorber 300 containing a second bed of solid adsorbent, or otherwise a second “regenerating” tar conversion reactor 300 containing a second bed of solid catalyst. The arrangement of valves includes first gasifier effluent inlet valve 50, second gasifier effluent inlet valve 55, first fresh gasifier feed inlet valve 60, and second fresh gasifier feed inlet valve 65. First and second gasifier effluent inlet valves 50, 55 may be configured to flow gasifier effluent 30 to either vessel 200 or 300 for use as the in-service tar adsorber or in-service tar conversion reactor, and may also be further configured to flow respective first portion 30a and/or second portion 30b of gasifier effluent 30 to these respective vessels. In the same manner, first and second fresh gasifier feed inlet valves 60, 65 may be configured to flow fresh gasifier feed 20 to either vessel 300 or 200 for use as the regenerating tar adsorber or regenerating tar conversion reactor. These valves may also be further configured to flow respective first portion 20a and/or third portion 20c of fresh gasifier feed 20 to these respective vessels, with second portion 20b being a component, optionally in combination with regeneration effluent 22 or cooled regeneration effluent 25, of oxygen-containing gasifier feed 5.

For example, during operation with vessel 200 being either the in-service tar adsorber or in-service tar conversion reactor and with vessel 300 being either the regenerating tar adsorber or regenerating tar conversion reactor, first gasifier inlet valve 50 may be open and second gasifier inlet valve 55 may be closed, to allow all of gasifier effluent 30 to be input to vessel 200 and contacted with a first bed of solid adsorbent or first bed of solid catalyst contained in this vessel. In addition, second fresh gasifier feed inlet valve 65 may be closed and first fresh gasifier feed inlet valve 60 may be open to an extent that allows first portion 20a of fresh gasifier feed 20 to be input to vessel 300 and contacted with a second bed of solid adsorbent or second bed of solid catalyst contained in this vessel. First portion 20a is sufficient for regeneration of the second bed, by contacting it under regeneration conditions to provide regeneration effluent 22 comprising CO, CO₂, H₂O and/or H₂ resulting from oxidation, cracking, and/or reforming of adsorbed tar and/or catalyst coke initially present on the surface of, or within pores of, the second bed of solid adsorbent or the second bed of solid catalyst, depending on whether the process utilizes tar adsorption or tar conversion. Regeneration effluent 22 may be subsequently cooled, in an optional cooling step, such as in the case of using regeneration effluent cooler 130 or other system or apparatus for the cooling of, and/or recovery of heat from, regeneration effluent 22 (e.g., to generate high pressure steam), to provide cooled regeneration effluent 25.

The relative amounts of first portion 20a and second portion 20b of fresh gasifier feed 20 used, respectively, for regeneration of the second bed contained in vessel 300 and for feeding directly to gasifier 100 (as a component of oxygen-containing gasifier feed 5) can be varied based on a number of operating parameters, and may be adjusted in response to measurements of such parameters. These parameters include the oxygen concentration of the fresh gasifier feed 20 and the oxygen concentration of oxygen-containing gasifier feed 5, with increases in concentrations of oxygen in the fresh gasifier feed 20 and/or the oxygen-containing gasifier feed directionally resulting in a greater amount of first portion 20a used for regeneration, relative to the second portion. According to other embodiments, the entire fresh gasifier feed 20 may be input, as first portion 20a, to vessel 300, with breakthrough oxygen in the regeneration effluent or cooled regeneration effluent providing the entire oxygen content of oxygen-containing gasifier feed 5. In any event, fresh gasifier feed 20 may comprise steam and oxygen in an amount sufficient for oxidation, cracking, and/or reforming of adsorbed tar and/or catalyst coke, under regeneration conditions used over a regeneration time period in vessel 300 that is commensurate with the time of operation that vessel 200 is used as an in-service tar adsorber or in-service tar conversion reactor.

In general, fresh gasifier feed 20 may comprise H₂O and O₂, as well as optionally CO₂, in a combined concentration of at least about 90 mol-%, at least about 95 mol-%, or at least about 99 mol-%. All of these components may serve as oxidants of the adsorbed tar and/or catalyst coke, during regeneration of spent adsorbent, although the propensity of these components for oxidation vary considerably. Representative regeneration conditions, used in second “regenerating tar adsorber” 300 or second “regenerating tar conversion reactor” 300, may include a temperature from about 400 °C (752 °F) to about 1000 °C (1832 °F), such as from about 550 °C (1022 °F) to about 850 °C (1562 °F). The regeneration time period may generally be sufficient to achieve a content of adsorbed tar and/or catalyst coke, remaining on the regenerated solid adsorbent or regenerated solid catalyst, of less than about 1 wt-%, less than about 0.5 wt-%, or even less than about 0.1 wt-%.

Advantageously, according to embodiments illustrated in the Figure, in which oxygen-containing gasifier feed 5 comprises (i) second portion 20b of fresh gasifier feed 20 and/or (ii) at least a portion of regeneration effluent 22 or at least a portion of cooled regeneration effluent 25, feeds to the overall gasification process can be utilized in an efficient and flexible manner, and CO₂ generated from regeneration can be retained in the process rather than being released to the atmosphere.

Following a time period (or other indication) of sufficient utilization with vessel 200 being either the in-service tar adsorber or in-service tar conversion reactor and with vessel 300 being either the regenerating tar adsorber or regenerating tar conversion reactor, first gasifier inlet valve 50 may be closed and second gasifier inlet valve 55 may be opened, to allow all of gasifier effluent 30 to be input to vessel 300 and contacted with the second bed of regenerated solid adsorbent or second bed of regenerated solid catalyst, as the case may be, contained in this vessel. In addition, second fresh gasifier feed inlet valve 65 may be opened to an extent that allows third portion 20c of fresh gasifier feed 20 to be input to vessel 200 and contacted with the first bed of solid adsorbent or first bed of solid catalyst contained in this vessel. Third portion 20c is sufficient for regeneration of the first bed, in the manner described above with respect to regeneration of the second bed in vessel 300. Using this arrangement of valves, it can be appreciated that one of vessels 200, 300 may be effectively “removed” from a given operation, such as a tar adsorption operation or a regeneration operation, and “replaced,” in view of the re-routed process flows, with the other vessel. Accordingly, vessels, and the respective beds of solid adsorbent or solid catalyst contained in these vessels, may be alternated between tar adsorption and solid adsorbent regeneration, or otherwise alternated between tar conversion and solid catalyst regeneration, over extended operating periods in which at least one of the vessels 200, 300 functions as an “in-service” tar adsorber or “in-service” tar conversion reactor. The complete re-routing of process flows to achieve the objective of alternating between tar adsorption and regeneration, or tar conversion and regeneration, may involve the use of further valves such as first and second product outlet valves 70, 80 and first and second regeneration outlet valves 75, 85, to route outlets from vessels 200, 300, to either the regeneration effluent, as a component of the oxygen-containing gasifier feed 5, or to the synthesis gas product.

In some embodiments, valves 50, 55 may be combined into a single valve, such as a multi-port valve. Multiple valves or a single valve can be used to to divert varying proportions of gasifier effluent 30, in first portion 30a and second portion 30b, to vessels 200, 300. Likewise, valves 60, 65 may be combined into a single valve, such as a multi-port valve. Multiple valves or a single valve can be used to divert varying proportions of fresh gasifier feed 20, in first portion 20a, second portion 20b, and third portion 20c, to vessels 300, 100, and 200, respectively. In the same manner, valves 70, 80 may be combined into a single valve (e.g., a multi-port valve) and/or valves 75, 85 may be combined into a single valve (e.g., a multi-port valve). Multiple valves 70, 80 or a single valve, and/or multiple valves 75, 85 or a single valve, may be used to divert varying portions of tar adsorber effluent/reactor effluent 32 and/or regeneration effluent 22 to gasifier feed 5 and synthesis gas product 40.

Overall, the arrangement of these valves 50, 55, 60, 65, 70, 75, 80, 85 allows for substantial flexibility in the manner in which flows of (a) gasifier effluent 30 and portions thereof 30a, 30b and/or (b) fresh gasifier feed 20 and portions thereof 20a, 20b, 20c, may be routed to either the in-service tar adsorber/tar conversion reactor or the regenerating tar adsorber/regenerating tar conversion reactor. This arrangement further allows for substantial flexibility in the manner in which flows of (c) the effluent from the tar adsorber/tar conversion reactor and/or (d) the effluent from the regenerating tar adsorber/regenerating tar conversion reactor, may be routed either to the regeneration effluent, as a component of the oxygen-containing gasifier feed 5, or to the synthesis gas product 40.

In the case of managing flows (a), the relative amounts of first portion 30a and second portion 30b used, respectively, for contacting with the first bed (e.g., comprising fresh adsorbent, fresh catalyst, regenerated adsorbent, or regenerated catalyst) contained in the “in-service” tar adsorber/tar conversion reactor 200 and for contacting with the second bed (e.g., comprising spent adsorbent or spent catalyst) contained in the “regenerating” tar adsorber/tar conversion reactor 300 can be varied based on a number of operating parameters. These parameters include the H₂:CO molar ratio of gasifier effluent 30 and/or the CO₂ concentration of gasifier effluent 30. In the case of the H₂:CO molar ratio, portions 30a, 30b of gasifier effluent 30 may be varied depending on whether this ratio is suitable or favorable for downstream reactions as described above, with a relatively greater amount of first portion 30a being diverted to “in-service” tar adsorber/tar conversion reactor 200 when the H₂:CO molar ratio approaches a target value. In the case of the CO₂ concentration, portions 30a, 30b of gasifier effluent 30 may be varied to retain CO₂ in the process, with a relatively greater amount of second portion 30b being diverted to “regenerating” tar adsorber/tar conversion reactor 300 when the CO₂ concentration exceeds a target value. According to representative embodiments, therefore, processes may comprise, in response to a measured H₂:CO molar ratio of gasifier effluent approaching a target H₂:CO molar ratio (e.g., any target value within a range from 0.5 to 2.5, such as any target value within a range from 1 to 2, for example a target value of 1), increasing a proportion of the gasifier effluent for contacting with the first bed and/or decreasing a proportion of the gasifier effluent for contacting with the second bed. A measured H₂:CO molar ratio “approaching” a target ratio may be indicated by a first measurement deviating from the target ratio (e.g., deviating by more than 5%, deviating by more than 10%, or deviating by more than 25%) and a second, subsequent measurement conforming to the target ratio (e.g., being within +/−5%, being within +/−10%, or being within +/−25%, respectively). Alternatively, or in combination, processes may comprise, in response to a measured CO₂ concentration of the gasifier effluent exceeding a target CO₂ concentration (e.g., any target value within a range from 2 mol-% to 30 mol-%, such as any target value within a range from 5 mol-% to 25 mol-%, for example a target value of 10 mol-%), increasing a proportion of the gasifier effluent for contacting with the second bed and/or decreasing a proportion of the gasifier effluent for contacting with the first bed.

In the case of managing flows (b), as noted above, the relative amounts of first portion 20a and second portion 20b of fresh gasifier feed 20 used, respectively, for regeneration of the second bed contained in vessel 300 and for feeding directly to gasifier 100 (as a component of oxygen-containing gasifier feed 5) can be varied based on a number of operating parameters, and may be adjusted in response to measurements of such parameters. These parameters include the oxygen concentration of fresh gasifier feed 20 and the oxygen concentration of oxygen-containing gasifier feed 5, with increases in concentrations of oxygen in the fresh gasifier feed 20 and/or the oxygen-containing gasifier feed directionally resulting in a greater amount of first portion 20a used for regeneration, or otherwise a greater combined amount of first and third portions 20a, 20c, relative to the second portion. According to representative embodiments, therefore, processes may comprise, in response to a measured O₂ concentration of the fresh gasifier feed or a measured O₂ concentration of the oxygen-containing gasifier feed, corresponding to a percentage of combustion of the carbonaceous feed exceeding a target percentage of combustion (e.g., any target value within a range from 20% to 70%, such as any target value within a range from 30% to 50%, for example a target value of 40 mol-%), increasing a proportion of the fresh gasifier feed for contacting with the second bed and/or decreasing a proportion of the fresh gasifier feed for contacting with the carbonaceous feedstock. Otherwise, the proportion of the fresh gasifier feed for contacting with the both the first and second beds in combination may be increased.

In the case of managing flows (c), the relative amounts of tar adsorber effluent/tar conversion reactor effluent 32 for providing greater or lesser contributions to (as components of) oxygen-containing gasifier feed 5 or synthesis gas product 40 can be varied based on a number of operating parameters. These parameters include the H₂:CO molar ratio of effluent 32 and/or the CO₂ concentration of effluent 32. In the case of the H₂:CO molar ratio, amounts of this effluent may be varied depending on whether this ratio is suitable or favorable for downstream reactions as described above, with a relatively greater amount being diverted to synthesis gas product 40 when the H₂:CO molar ratio approaches a target value. In the case of the CO₂ concentration, amounts may be varied to retain CO₂ in the process, with a relatively greater amount being diverted to oxygen-containing gasifier feed 5 when the CO₂ concentration exceeds a target value. According to representative embodiments, therefore, processes may comprise, in response to a measured H₂:CO molar ratio of the tar adsorber effluent or tar conversion reactor effluent approaching a target H₂:CO molar ratio (e.g., any target value within a range from 0.5 to 2.5, such as any target value within a range from 1 to 2, for example a target value of 1), increasing a proportion of this effluent provided as a component of the synthesis gas product and/or decreasing a proportion this effluent provided as component of the oxygen-containing gasifier feed. A measured H₂:CO molar ratio “approaching” a target ratio may be indicated as described above with respect to the case of managing flows (a). Alternatively, or in combination, processes may comprise, in response to a measured CO₂ concentration of the tar adsorber effluent or tar conversion reactor effluent exceeding a target CO₂ concentration (e.g., any target value within a range from 2 mol-% to 30 mol-%, such as any target value within a range from 5 mol-% to 25 mol-%, for example a target value of 10 mol-%), increasing a proportion of this effluent provided as component of the oxygen-containing gasifier feed and/or decreasing a proportion of this effluent provided as a component of the synthesis gas product.

In the case of managing flows (d), the relative amounts of regeneration effluent 22 for providing greater or lesser contributions to (as components of) oxygen-containing gasifier feed 5 or synthesis gas product 40 can be varied based on a number of operating parameters. These parameters include the H₂:CO molar ratio of regeneration effluent 22 and/or the CO₂ concentration of regeneration effluent 22. In the case of the H₂:CO molar ratio, amounts of this effluent may be varied depending on whether this ratio is suitable or favorable for downstream reactions as described above, with a relatively greater amount being diverted to synthesis gas product 40 when the H₂:CO molar ratio approaches a target value. In the case of the CO₂ concentration, amounts may be varied to retain CO₂ in the process, with a relatively greater amount being diverted to oxygen-containing gasifier feed 5 when the CO₂ concentration exceeds a target value. According to representative embodiments, therefore, processes may comprise, in response to a measured H₂:CO molar ratio of the regeneration effluent approaching a target H₂:CO molar ratio (e.g., any target value within a range from 0.5 to 2.5, such as any target value within a range from 1 to 2, for example a target value of 1), increasing a proportion of this effluent provided as a component of the synthesis gas product and/or decreasing a proportion this effluent provided as component of the oxygen-containing gasifier feed. A measured H₂:CO molar ratio “approaching” a target ratio may be indicated as described above with respect to the case of managing flows (a). Alternatively, or in combination, processes may comprise, in response to a measured CO₂ concentration of the regeneration effluent exceeding a target CO₂ concentration (e.g., any target value within a range from 2 mol-% to 30 mol-%, such as any target value within a range from 5 mol-% to 25 mol-%, for example a target value of 10 mol-%), increasing a proportion of this effluent provided as component of the oxygen-containing gasifier feed and/or decreasing a proportion of this effluent provided as a component of the synthesis gas product.

Overall, in the case of managing flows of (a), this may be governed by the composition of the gasifier effluent, whereas in the case of managing flows of (c) and/or (d), this may be governed by the compositions of the effluents from vessels 200, 300. More particularly, these flows may be managed according to the extent desired to retain such compositions in the process, as a component of the oxygen-containing gasifier feed, or otherwise include such compositions in the synthesis gas product. In the case of managing flows of (b), this may be governed by the composition of the fresh gasifier feed and, more particularly these flows may be managed according to the needs of maintaining a suitable percentage of combustion of the carbonaceous feed as well as effective regeneration of spent adsorbent or spent catalyst. According to other embodiments, managing flows (a), (b), (c), and/or (d) may be governed by (i) increasing or maximizing the yield of the synthesis gas product or (ii) increasing or maximizing the extent to which carbon is retained in the process, such as by decreasing or minimizing the extent to which carbon is removed as CO₂ with synthesis gas product 40.

Overall, aspects of the invention relate to improvements in the control and management of gasifier effluent tar, leading to potential process integration strategies and other advantages as described herein. Those skilled in the art, having knowledge of the present disclosure, will recognize that various changes can be made to these processes in attaining these and other advantages, without departing from the scope of the present disclosure. As such, it should be understood that the features of the disclosure are susceptible to modifications and/or substitutions, and the specific embodiments illustrated and described herein are for illustrative purposes only, and not limiting of the invention as set forth in the appended claims.

1. A process for gasification of a carbonaceous feed to produce a synthesis gas product the process comprising:
in a gasifier, contacting the carbonaceous feed with an oxygen-containing gasifier feed, under gasification conditions, to provide a gasifier effluent comprising gasifier effluent tar;
in a tar adsorber, contacting at least a portion of the gasifier effluent with at least a first bed of a solid adsorbent, under tar adsorption conditions, to adsorb at least a portion of the gasifier effluent tar and provide a tar adsorber effluent having a reduced amount of tar; and
recovering the synthesis gas product from the tar adsorber effluent.

2. The process of claim 1, wherein the solid adsorbent comprises a tar adsorptive material selected from the group consisting of a zeolite, a non-zeolitic molecular sieve (zeotype), a metal oxide, and a clay.

3. The process of claim 2, wherein the metal oxide is modified with sulfate ions.

4. (canceled)

5. The process of claim 1, wherein the solid adsorbent comprises a tar adsorptive material having a surface area of at least about 10 m²/g.

6. The process of claim 1, wherein the solid adsorbent comprises one or more metals having activity for catalytic conversion of the gasifier effluent tar under the tar adsorption conditions, in an amount, or a combined amount, of less than about 0.1 wt-%.

7. The process of claim 1, wherein the tar adsorber effluent comprises substantially no CO, CO₂, or H₂ resulting from conversion of the gasifier effluent tar.

8. The process of claim 1, wherein the gasifier effluent is obtained following one or more steps of removing solids, upstream of the tar adsorber.

9. The process of claim 8, wherein the one or more steps of removing solids comprise a centrifugation step and a filtration step.

10. The process of claim 9, wherein the centrifugation step and the filtration step are performed upstream and downstream, respectively, of a step of cooling the gasifier effluent.

11. The process of claim 1, wherein the gasifier effluent in the tar adsorber, as well as from the gasifier to the tar adsorber, is maintained at a temperature above a condensation temperature.

12. The process of claim 1, wherein the tar adsorption conditions include a temperature from about 400 °C (752 °F) to about 600 °C (1112 °F).

13. The process of claim 1, further comprising replacing at least a portion of the first bed of the solid adsorbent based on an indication of sufficient utilization.

14. The process of claim 13, wherein the indication of sufficient utilization is selected from the group consisting of (i) a time of operation, optionally in view of one or more process parameters, (ii) a pressure drop across the tar adsorber, (iii) a breakthrough of tar, or a combination thereof.

15. The process of claim 13, wherein the at least portion of the first bed of the solid adsorbent is replaced with at least a portion of a second bed of the solid adsorbent, following a regeneration of the second bed of the solid adsorbent.

16. The process of claim 15, wherein the regeneration comprises contacting a first portion of a fresh gasifier feed with the second bed of the solid adsorbent under regeneration conditions to provide a regeneration effluent comprising CO, CO₂, H₂O, and/or H₂ resulting from oxidation, cracking, and/or reforming of adsorbed tar.

17. The process of claim 16, wherein the oxygen-containing gasifier feed comprises a second portion of the fresh gasifier feed.

18. The process of claim 16, wherein the oxygen-containing gasifier feed comprises at least a portion of the regeneration effluent.

19. The process of claim 1, wherein the synthesis gas product is recovered from the tar adsorber effluent following steps of cooling and/or scrubbing.

20. An integrated process for gasification of a carbonaceous feed, tar adsorption, and solid adsorbent regeneration, the process comprising:
in a gasifier, contacting the carbonaceous feed with an oxygen-containing gasifier feed, under gasification conditions, to provide a gasifier effluent comprising gasifier effluent tar;
alternating first and second beds of a solid adsorbent between
(i) tar adsorption, by contact with the gasifier effluent under tar adsorption conditions, to adsorb at least a portion of the gasifier effluent tar and provide a tar adsorber effluent having a reduced amount of tar, and
(ii) regeneration, by contact with a first portion of a fresh gasifier feed under regeneration conditions, to oxidize, crack, and/or reform at least a portion of adsorbed tar to CO, CO₂, and/or H₂, and provide a regeneration effluent; and
recovering a synthesis gas product from the tar adsorber effluent.

21. The process of claim 20, wherein (i) the oxygen-containing gasifier feed comprises a second portion of the fresh gasifier feed, and/or (ii) the oxygen-containing gasifier feed comprises at least a portion of the regeneration effluent.
